(19) United States
(12) Patent Application Publication
(10) Pub. No.: US 2018/0287167 A1
(43) Pub. Date: Oct. 4, 2018

(54) HIGH PERFORMANCE NEGATIVE ELECTRODE ACTIVE MATERIALS FOR SODIUM ION BATTERIES

(71) Applicant: Samsung Electronics Co., Ltd., Gyeonggi-do (KR)

(72) Inventors: Masoud Aryanpour, Malden, MA (US); Yan Wang, Brookline, MA (US)

(21) Appl. No.: 15/833,218

(22) Filed: Dec. 6, 2017

Related U.S. Application Data
(60) Provisional application No. 62/481,469, filed on Apr. 4, 2017.

(51) Int. Cl. H01M 4/96; H01M 4/04; H01M 6/04

(52) U.S. Cl. CPC H01M 4/96; H01M 6/045; H01M 4/0416

(57) ABSTRACT

A negative electrode active material for a sodium-ion battery, the negative electrode active material including: a layered carbonaceous material; and a composition of the formula NaₓSn_{y-z}M_{z} disposed between layers of the layered carbonaceous material, wherein M is Ti, K, Ge, Sb, P, or a combination thereof, and 0<x≤15, 1≤y≤5, and 0≤z≤1.

### CROSS REFERENCE TO RELATED APPLICATIONS

This application claims the benefit, under 35 U.S.C. § 119(e), of U.S. Provisional Patent Application Ser. No. 62/481,469, filed on Apr. 4, 2017, which is hereby incorporated by reference in its entirety.

### BACKGROUND

Lithium (Li) ion batteries, while being the most prominent type of rechargeable battery for portable electronics applications, have limited applicability because of the high cost of lithium and their safety. Sodium (Na) ion batteries on the other hand, although not as developed as lithium-ion batteries, present numerous unsolved challenges. For example, sodium-ion batteries currently provide significantly less capacity than lithium-ion batteries.

Therefore, in order to overcome the technical challenges associated with Na-ion batteries, there remains a need for electrode materials that can intercalate greater amounts of sodium, in particular, an improved sodium-ion negative electrode active material.

### SUMMARY

Disclosed is a negative electrode active material for a sodium-ion battery, the negative electrode active material including: a layered carbonaceous material; and a composition of the formula NaₓSn_{y-z}M_{z} disposed between layers of the layered carbonaceous material, wherein M is Ti, K, Ge, P, or a combination thereof, and 0<x≤15, 1≤y≤5, and 0≤z≤1.

A negative electrode includes the negative electrode active material.

A sodium-ion battery includes a positive electrode comprising a positive electrode active material; a negative electrode including the above described negative electrode active material; and an electrolyte between the positive electrode and the negative electrode.

Also disclosed is a device including the sodium-ion battery.

Also disclosed is a method of making the negative electrode active material, the method including adding the composition to a suspension comprising the layered carbonaceous material to provide a mixture; immersing a metal foil in the mixture under conditions effective to adsorb the layered carbonaceous material and the composition onto the metal foil, wherein the composition is disposed between the layers of the layered carbonaceous material to provide the negative electrode active material adsorbed onto the metal foil; washing the metal foil to remove unadsorbed layered carbonaceous material and composition; and detaching the negative electrode active material from the metal foil.

The above described and other features are exemplified by the following figures and detailed description.

### BRIEF DESCRIPTION OF THE DRAWINGS

The above and other advantages and features of this disclosure will become more apparent by describing in further detail exemplary embodiments thereof with reference to the accompanying drawings, in which:

FIG. 1 shows a computational model for titanium-doped Na₉Sn₄; and

FIG. 2 shows a computational model for insertion of Na₉Sn₄ between graphene layers.

### DETAILED DESCRIPTION

The present inventor has discovered a sodium-ion negative electrode active material that provides improved performance when used in a negative electrode for a sodium-ion battery. In the disclosed negative electrode active material, a tin-based sodium alloy is disposed between layers of a layered carbonaceous material. Advantageously, the negative electrode material provides the desirable voltage and capacity of the tin-based sodium alloy, and provides improved cycle life. While not wanting to be bound by theory, it is believed that the improved cycle life is a result of reduced volume expansion and contraction of the disclosed negative electrode active material on charge and discharge, avoiding particle fracture mechanisms that are understood to cause capacity fade. In addition, it has been surprisingly discovered that doping the tin-based sodium alloy with Ti, K, Ge, Sb, P, or a combination thereof can provide further improvement, in particular by reducing the average voltage, which results in improved specific energy and energy density. Thus, an embodiment disclosed herein is high performance sodium-ion negative electrode material in which a tin-based sodium alloy is disposed between layers of a carbonaceous material to provide a high capacity, low volume change negative electrode active material.

In an aspect, disclosed is a negative electrode active material for a sodium-ion battery, the negative electrode active material comprising a layered carbonaceous material; and a tin composition of the formula NaₓSn_{y-z}M_{z} disposed between layers of the layered carbonaceous material, wherein M is Ti, K, Ge, Sb, P, or a combination thereof, and 0<x≤15, 1≤y≤5, and 0≤z≤1. The layered carbonaceous material can be a host for the composition, which can be a guest within the host.

For the layered carbonaceous material, any suitable layered carbonaceous material can be used. Exemplary layered carbonaceous materials can include, but are not limited to, amorphous carbon, natural graphite, artificial graphite, graphene, graphene oxide, reduced graphene oxide, carbon nanotubes or a combination thereof. Carbon black, such as Ketjen black (a carbon black product of AkzoNobel) and Super-P carbon (a carbon black product of Timcal), mesoporous carbon, mesocarbon microbeads, oil furnace black, Super-P carbon, acetylene black, and lamp black are mentioned. Each of the foregoing carbonaceous materials may comprise graphene layers in a configuration suitable for hosting the composition between adjacent layers. The layered carbonaceous material may have a Brunauer, Emmett and Teller (BET) surface area of 50 m²/g to about 2000 m²/g, specifically 500 m²/g to about 1500 m²/g. The layered carbonaceous material may have an average particle size of about 50 nanometers (nm) to about 1000 nm, specifically 100 nm to about 500 nm. Particle size may be measured by light scattering.

In an embodiment, the layered carbonaceous material comprises graphene. Graphene comprises a single layer of carbon in which a plurality of carbon atoms are covalently bonded to each other to provide a polycyclic aromatic molecule. The covalently bonded carbon atoms form 6-membered rings as a repeating unit, and can also form 5-membered rings or 7-membered rings. Accordingly, in the unit graphene layer, the covalently bonded carbon atoms (usually, sp² hybridized) form a single layer. In an embodiment the tin-based sodium alloy is disposed between layers of graphene.

In an embodiment the layered carbonaceous material comprises graphite. Graphite comprises a plurality of graphene layers. The graphite can comprise any suitable number of graphene layers and can have any suitable a thickness. A particle of the graphite can comprise 2 to 1000, 4 to about 500, or 8 to 250 graphene layers. Also, the graphite can have any suitable, e.g., a thickness of 10 nanometers (nm) to 1000 nm, 20 nm to 800 nm, or 40 nm to 600 nm.

In the negative electrode active material, the composition of the formula NaₓSn_{y-z}M_{z} is interposed between layers, e.g. between adjacent layers, of the layered carbonaceous material. For example, the composition can be disposed between graphene layers of the layered carbonaceous material. In an embodiment wherein the layered carbonaceous material comprises graphite, the composition is disposed between graphene layers of the graphite. In an embodiment, M is Ti (titanium), K (potassium), Ge (germanium), Sb (antimony), P (phosphorus), or a combination thereof. Use of Ti and K are specifically mentioned. Also, 0<x≤15, 0<x≤13, 0.1<x≤11, or 0.5<x≤9; 1≤y≤5, 1.2≤y≤4.5, 1.4≤y≤4, or 1.6≤y≤3.5; and 0≤z≤1, 0.1≤z≤0.9, 0.2≤z≤0.8, or 0.4≤z≤0.7. A particle of the composition can have any suitable shape, and can be spherical or cylindrical, for example.

In an embodiment, the composition can include Na₉Sn₄ (i.e., wherein x, y, and z in the above formula are 9, 4, and 0, respectively). In an embodiment, the composition can include Na₁₅Sn₄ (i.e., wherein x, y, and z in the above formula are 15, 4, and 0, respectively). In an embodiment, y is preferably about 4. In an embodiment, z in the above formula can be 0<z≤1, and M can preferably be Ti or K.

In an embodiment the composition comprising NaₓSn_{y-z}M_{z} can be arranged between the unit graphene layers at a regular interval, or can be present at an irregular interval. In addition, the number of unit graphene layers interposed between adjacent particles of the composition can be regular or irregular. For example, 1 to 100, 2 to 80, 4 to 60, or 8 to 40 graphene layers may be interposed between particles of the composition. Also, on average, 1 to 100, 2 to 80, 4 to 60, or 8 to 40 graphene layers may be interposed between adjacent particles of the composition.

The layered carbonaceous material and the composition can be present in any amount effective to provide a negative electrode active material exhibiting the desired properties. In an embodiment, the preferred amount of the layered carbonaceous material and the composition can be expressed in terms of the weight ratio of the Sn (tin) of the composition to the C (carbon) of the carbonaceous material. Thus, in some embodiments, the composition and layered carbonaceous material are present in an amount effective to provide a Sn:C (tin:carbon) weight ratio of 1:10 to 10:1, 1:5 to 5:1, 1:4 to 3:1, 1:3 to 2:1, 1:3 to 1:1, or 1:2 to 2:3. In an embodiment, a content of the composition is 20 weight percent (wt %) to 90 wt %, 30 wt % to 80 wt %, or 40 wt % to 70 wt %, based on a total weight of the negative electrode active material. Also, a content of the carbon can be 80 wt % to 10 wt %, 70 wt % to 20 wt %, or 60 wt % to 30 wt %, based on a total weight of the negative electrode active material.

The disclosed negative electrode active material provides several desired characteristics including, for example, improved capacity, improved specific energy, improved energy density, and improved cycle life. As noted above, while not wanting to be bound by theory, it is understood that the improved cycle life is a result of the reduced volume expansion and contraction upon cycling of the disclosed negative electrode active material. Relative to the composition when not interposed between layers of a layered carbonaceous material, the disclosed negative electrode active material provides reduced volume expansion on charge by a factor of greater than or equal to 3, e.g., 3 to 7, or 4 to 5.

In addition, it has been surprisingly discovered that inclusion, e.g., doping, of certain elements in the composition provides improved voltage. While the fundamental reason for the improved voltage is not fully understood, it has been observed that the average voltage of the composition can be reduced by inclusion of Ti, K, Ge, Sb, P, or a combination thereof. For example, as is further discussed below, inclusion of Ti provided an average voltage of 0.1 volts (V) versus Na/Na⁺, relative to 0.3 V without the Ti. Alternatively, inclusion of K provided an average voltage of −0.02 V versus Na/Na⁺.

When disposed between layers of the layered carbonaceous material a further improvement in voltage was observed. For example, the average voltage of Na₉Sn₄ when disposed between layers of the layered carbonaceous material provided an average voltage of −1.1 V, a 1.4 V improvement relative to Na₉Sn₄. In an embodiment, the average voltage of the negative electrode active material is 0.5 V to −1.2 V, 0.4 V to −1.1 V, or 0.3 V to −1.0 V, versus Na/Na⁺.

Thus, in an embodiment, the disclosed negative electrode active material can advantageously exhibit one or more of the following features.

In an embodiment, the negative electrode active material can exhibit a volume change upon intercalation with sodium to a voltage of −0.1 volts versus Na/Na⁺ of less than 70%, based on a total volume before intercalation. As used herein the term “intercalation” is to be construed broadly and may comprise alloying or other mechanisms of inclusion of Na, recognizing that inclusion of Na in the negative electrode active material may comprise disposing Na between layers of the layered carbonaceous material and/or alloying of the Na with the composition.

In an embodiment, the negative electrode active material can exhibit a volume change upon intercalation with sodium to a voltage of −0.1 volts versus Na/Na⁺ which is less than a volume change of the same composition when not disposed between layers of the layered carbonaceous material (e.g., graphene layers).

In some embodiments, the negative electrode active material exhibits an average voltage of less than 0 volts versus Na/Na⁺.

In some embodiments, the negative electrode active material exhibits an average voltage of 0 to −1.1 volts versus Na/Na⁺.

Another aspect of the present disclosure if a negative electrode comprising the negative electrode active material.

The negative electrode active material can be made by disposing the composition between the layers of the layered carbonaceous material. Specifically, the composition can be disposed between the layers of the carbonaceous material. The composition can be intercalated or diffused in to the layered carbonaceous material by any suitable method, for example by two-region vapor phase transport, constant temperature vapor phase transport, an electrochemical method, or liquid phase intercalation. In a preferred embodiment, the negative electrode active material can be made through an electrostatic adsorption method. In an embodiment, the active material can be made by preparing an aqueous suspension comprising the layered carbonaceous material, and adding to the suspension the composition, providing a mixture. In an embodiment, the pH of the mixture can be adjusted to be acidic if desired, for example, to a pH of less than 6, or less than 4, preferably 1 to 3, or 1.5 to 2.5, more preferably about 2. Adjusting the pH can be by addition of an acidic aqueous solution (e.g., using hydrochloric acid and the like). The suspension can be homogenized, for example using sonication, to ensure homogenous distribution of the layered carbonaceous material and the composition. If desired, a dispersing agent or surfactant, such as an alcohol, such as ethanol or methanol, can be optionally included. A metal foil can then be immersed in the suspension (e.g., a zinc foil, or the like) under conditions effective to adsorb to host onto the metal foil. For example, the metal foil can be immersed in the suspension at a temperature of about 25° C. for a time of 1 to 10 hours, or 2 to 5 hours. Without wishing to be bound by theory, it is believed that the composition is disposed between the layers of the layered carbonaceous material when the layered carbonaceous material adsorbs to the metal foil, thus providing the negative electrode active material absorbed onto the metal foil. The negative electrode active material can be detached from the metal foil, for example under acidic etching conditions, and optionally washed, e.g., with tetrahydrofuran (THF), ethanol, or water, to remove unadsorbed layered carbonaceous material and/or composition. Free-standing negative electrode active material can be prepared by removal of water, for example by lyophilization. In some embodiments, the negative electrode active material can further be calcined under conditions effected to reduce the carbonaceous material, if needed (e.g., at a temperature of about 800° C. for several hours).

The negative electrode active material described herein can be incorporated into a sodium-ion battery. Thus, another aspect of the present disclosure is a sodium-ion battery comprising the negative electrode active material. The sodium-ion battery can be fabricated in any suitable shape, and can be prismatic or cylindrical, and can have a wound or stacked configuration.

The sodium-ion battery comprises a positive electrode comprising a positive electrode active material, a negative electrode comprising the above-described negative electrode active material, and an electrolyte layer between the positive electrode and the negative electrode. In some embodiments, the sodium-ion battery can further comprises a separator disposed between the positive electrode and the negative electrode.

The negative electrode can be produced by forming a negative active material composition including the negative active material, and optionally, a conductive agent, and a binder, or by coating the composition on a current collector, such as a copper foil. Manufacturing of the negative electrode is not limited to the foregoing, and can the negative electrode can be manufactured by any suitable methods, such as roll-to-roll methods used in other battery technologies.

The binder can facilitate adherence between components of the negative electrode, such as the negative active material and the conductor, and adherence of the negative electrode to a current collector. Examples of the binder can include polyacrylic acid (PAA), polyvinylidene fluoride, polyvinyl alcohol, carboxymethyl cellulose (CMC), starch, hydroxypropyl cellulose, regenerated cellulose, polyvinylpyrrolidone, tetrafluoroethylene, polyethylene, polypropylene, ethylene-propylene-diene monomer (EPDM), sulfonated EPDM, styrene-butadiene-rubber, fluorinated rubber, a copolymer thereof, or a combination thereof. The amount of the binder can be in a range of about 1 part by weight to about 10 parts by weight, for example, in a range of about 2 parts by weight to about 7 parts by weight, based on a total weight of the negative active material. When the amount of the binder is in the range above, e.g., about 1 part by weight to about 10 parts by weight, the adherence of the negative electrode to the current collector may be suitably strong.

The conductive agent can include, for example, carbon black, carbon fiber, graphite, or a combination thereof. The carbon black can be, for example, acetylene black, Ketjen black, Super P carbon, channel black, furnace black, lamp black, thermal black, or a combination thereof. The graphite can be a natural graphite or an artificial graphite. A combination comprising at least one of the foregoing can be used. The negative electrode can additionally include an additional conductor other than the carbonaceous conductor described above. The additional conductor can be an electrically conductive fiber, such as a metal fiber; a metal powder such as a fluorinated carbon powder, an aluminum powder, or a nickel powder; a conductive whisker such as a zinc oxide or a potassium titanate; or a polyphenylene derivative. A combination comprising at least one of the foregoing can be used.

The positive electrode can be produced from a positive active material composition including a positive active material, and optionally, a conductive agent, and a binder. The positive active material can be a compound in which sodium intercalation or alloying reversibly occurs, such as an oxide of the formula NaM¹ₐO₂ such as NaFeO₂, NaMnO₂, NaNiO₂, or NaCoO₂; or an oxide represented by the formula NaMn₁₋ₐM¹ₐO₂, wherein M¹ is at least one transition metal element, and 0≤a<1. Representative positive active materials include Na[Ni_{1/2}Mn_{1/2}]O₂, Na_{2/3} [Fe_{1/2}Mn_{1/2}]O₂, and the like; an oxide represented by Na_{0.44}Mn₁₋ₐM¹ₐO₂, an oxide represented by Na_{0.7}Mn₁₋ₐM¹ₐ O_{2.05} an (wherein M¹ is at least one transition metal element, and 0≤a<1); an oxide represented by Na_{b}M²_{c}Si₁₂O₃₀ as Na₆Fe₂Si₁₂O₃₀ or Na₂Fe₅Si₁₂O (wherein M² is at least one transition metal element, 2≤b≤6, and 2≤c≤5); an oxide represented by Na_{d}M³ₑSi₆O₁₈ such as Na₂Fe₂Si₆O₁₈ or Na₂MnFeSi₆O₁₈ (wherein M³ is at least one transition metal element, 3≤d≤6, and 1≤e≤2); an oxide represented by Na_{f}M⁴_{g}Si₂O₆ such as Na₂FeSiO₆ (wherein M⁴ is at least one element selected from transition metal elements, magnesium (Mg) and aluminum (Al), 1≤f≤2 and 1≤g≤2); a phosphate such as NaFePO₄, Na₃Fe₂(PO₄)₃, Na₃V₂(PO₄)₃, Na₄Co₃(PO₄)₂P₂O₇ and the like; a borate such as NaFeBO₄ or Na₃Fe₂(BO₄)₃; a fluoride represented by NaₕM⁵F₆ such as Na₃FeF₆ or Na₂MnF₆ (wherein M⁵ is at least one transition metal element, and 2≤h≤₃), a fluorophosphate such as Na₃V₂(PO₄)₂F₃, Na₃V₂(PO₄)₂FO₂ and the like. The positive active material is not limited to the foregoing and any suitable positive active material that is used in the art can be used. In an embodiment, the positive active material preferably comprises a layered-type oxide cathode material such as NaMnO₂, Na[Ni_{1/2}Mn_{1/2}]O₂ and Na_{2/3}[Fe_{1/2}Mn_{1/2}]O₂, a phosphate cathode such as Na₃V₂(PO₄)₃ and Na₄Co₃(PO₄)₂P₂O₇, or a fluorophosphate cathode such as Na₃V₂(PO₄)₂F₃ and Na₃V₂(PO₄)₂FO₂. A combination comprising at least one of the foregoing positive active materials can be used. The type and the amounts of the binder, the conductive agent, and the solvent used to prepare the composition for forming the positive active material layer can be the same as those for preparing the composition for forming the negative active material layer described above.

As the separator, a porous olefin film such as polyethylene and polypropylene, and polymer electrolyte can be used. The separator can be porous, and a diameter of a pore of the separator can be in a range of about 0.01 micrometer (μm) to about 10 μm, and a thickness of the separator can be in a range of about 5 μm to about 300 μm. In some embodiments, the separator can be a woven or a non-woven fabric comprising an olefin-based polymer such as polypropylene or polyethylene; or a glass fiber.

In an embodiment, the electrolyte can be a liquid electrolyte and can include a polar aprotic solvent and a sodium salt. The polar aprotic solvent can be dimethylether, diethylether, dimethyl carbonate, diethyl carbonate, ethylmethyl carbonate, dipropyl carbonate, methylpropyl carbonate, ethylpropyl carbonate, ethylene carbonate, propylene carbonate, butylene carbonate, fluoroethylene carbonate, methyl acetate, ethyl acetate, n-propyl acetate, dimethylacetate, methyl propionate, ethyl propionate, γ-butyrolactone, decanolide, valerolactone, mevalonolactone, caprolactone, dibutyl ether, tetraglyme, diglyme, polyethylene glycol dimethylether, dimethoxy ethane, 2-methyl tetrahydrofuran, 2,2-dimethyl tetrahydrofuran, 2,5-dimethyl tetrahydrofuran, cyclohexanone, triethylamine, triphenylamine, triether phosphine oxide, acetonitrile, dimethyl formamide, 1,3-dioxolane, and sulfolane, but the organic solvent is not limited thereto and any suitable solvent can be used. In an embodiment, the solvent preferably comprises a carbonate ester, and more preferably comprises propylene carbonate.

The sodium salt used as the electrolyte can be, for example, NaClO₄, NaPF₆, NaBF₄, NaCF₃SO₃, NaN(CF₃SO₂)₂, NaN(C₂F₅SO₂)₂, NaC(CF₃SO₂)₃ and the like. In an embodiment, the liquid electrolyte preferably comprises NaClO₄, NaPF₆, or a combination thereof. The sodium salt is not limited to the foregoing and any suitable sodium salt can be used.

The sodium salt can be present in the electrolyte solution in any suitable concentration. Use of 0.1 molar (M) to 2 M, or 0.5 M to 1.5 M of the sodium salt is mentioned.

In an embodiments, the battery can be a solid sodium battery which comprises a solid-state electrolyte. For example, the solid-state electrolyte can be an inorganic solid electrolyte, such as an oxide-type (e.g., NASICON or Na₁₊ₓZr₂SiₓP₃₋ₓO₁₂, 0<x<3) or a sulfide type (e.g., Na₃PS₄); or a polymer electrolyte, such as poly(ethylene oxide)₈:NaAsF₆. The solid-state electrolyte is not limited thereto, and any suitable solid-state electrolyte can be used in the battery of the present disclosure.

The sodium-ion battery can be manufactured by disposing a separator between the positive electrode and the negative electrode and supplying an electrolyte thereto. For example, the sodium-ion battery can be manufactured by sequentially laminating the negative electrode, the separator, and the positive electrode; winding or folding the laminated structures, then enclosing the would or folded structure in a cylindrical or rectangular battery case or pouch, and subsequently disposing the liquid electrolyte into the battery case or pouch to provide the sodium ion battery. Disposing the liquid electrolyte into the case or pouch can be by, for example, injecting the liquid electrolyte.

This disclosure is further illustrated by the following examples, which are non-limiting.

### Examples

Various sodium compounds were reviewed for their stability and performance using quantum chemical computations. The compounds investigated are listed in Table 1.

TABLE 1

| Formula | # of atoms | Space Group |
|---|---|---|
| NaSn | 32 | 142 |
| Na₉Sn₄ | 4 | 63 |
| Na₁₅Sn₄ | 4 | 220 |
| Na_{14.8}Sn₄ | 2 | 62 |
| Na_{1.17}Sn₂ | 24 | 13 |
| NaSn₅ | 2 | 113 |
| NaSn₂ | 16 | 12 |
| SnTi₂ | 2 | 194 |
| SnTi₃ | 1 | 221 |
| Sn₅Ti₆ | 4 | 71 |
| Sn₃Ti₂ | 8 | 64 |
| Sn₃Ti₅ | 2 | 193 |

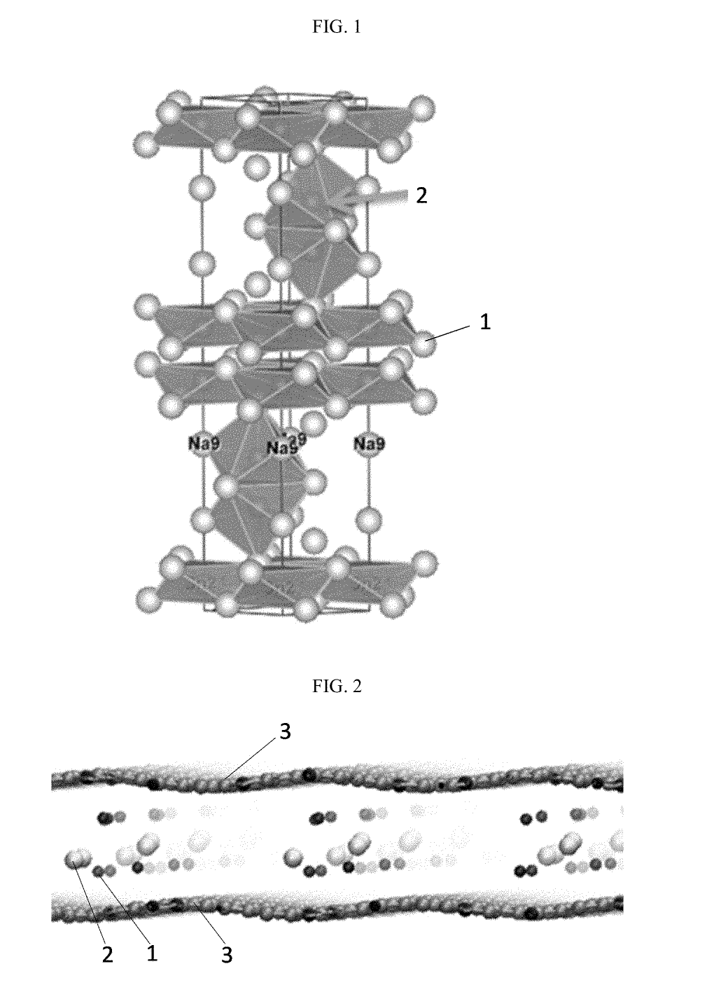

Table 2 shows an example of a computation where Na₉Sn was doped by Ti. A computational model of the Ti-doped Na₉Sn structure is illustrated in FIG. 1. FIG. 1 shows Na atoms, labelled “1”, as well the Sn sites, labelled “2”. Upon doping with Ti, a portion of the Sn sites 2 can be substituted by Ti.

TABLE 2

| Property | Na₉Sn₄ | Na₉Sn_{3.5}Ti_{0.5} |
|---|---|---|
| Theoretical Capacity (mAh/g) | 354 | 373 |
| Voltage (V vs. Na) | 0.304 | 0.106 |
| Energy above convex hull (eV) | 0.0 | 0.12 |
| Stability | stable | stable |

The insertion of Na₉Sn₄ was tested between graphene layers, illustrated in FIG. 2. Specifically, FIG. 2 shows a computational model for the insertion of the Na₉Sn₄ between graphene layers. Sodium atoms are labelled as “1”, tin atoms are labelled as “2”, and the graphene layers are labelled as “3”. A comparison of the results is provided in Table 3.

TABLE 3

| | | Average | % Volume | |
|---|---|---|---|---|
| Compound | Model | Voltage | Change | Capacity |
| Na₉Sn₄ | Na₁₈Sn₈ | 0.304 | −71.7 | 354 |
| Ti—Na₉Sn₄ | Na₁₈Sn₇Ti | 0.106 | −72.1 | 373 |
| K—Na₉Sn₄ | Na₁₇KSn₈ | −0.019 | −71.9 | |
| Na₉Sn₄-Graphene | Na₉Sn₄-Graphene | −1.072 | −23.0 | |

As shown in Table 3, intercalation of the Na₉Sn₄ between the graphene layers resulted in a significantly reduced volume change. Additionally, the average voltage was −1.072 V, compared to 0.304 V for Na₉Sn₄ not intercalated between graphene layers. Thus, a significant improvement in negative electrode active materials is provided by the present disclosure.

This disclosure further encompasses the following embodiments, which are non-limiting.

### Embodiment 1

A negative electrode active material for a sodium-ion battery, the negative electrode active material comprising: a layered carbonaceous material; and a composition of the formula NaₓSn_{y-z}M_{z} disposed between layers of the layered carbonaceous material, wherein M is Ti, K, Ge, Sb, P, or a combination thereof, and 0<x≤15, 1≤y≤5, and 0≤z≤1.

### Embodiment 2

The negative electrode active material of embodiment 1, wherein the layered carbonaceous material comprises amorphous carbon, natural graphite, artificial graphite, graphene, graphene oxide, reduced graphene oxide, carbon nanotubes, or a combination thereof.

### Embodiment 3

The negative electrode active material of embodiment 1 or 2, wherein the composition is disposed between graphene layers of the layered carbonaceous material.

### Embodiment 4

The negative electrode active material of any of embodiments 1 to 3, wherein the layered carbonaceous material comprises graphene.

### Embodiment 5

The negative electrode active material of any of embodiments 1 to 4, wherein the layered carbonaceous material comprises graphite and the composition is disposed between adjacent graphene layers of the graphite.

### Embodiment 6

The negative electrode active material of any of embodiments 1 to 5, wherein the composition comprises Na₉Sn₄.

### Embodiment 7

The negative electrode active material of any of embodiments 1 to 5, wherein the composition comprises Na₁₅Sn₄.

### Embodiment 8

The negative electrode active material of any of embodiments 1 to 5, wherein 0≤z≤1 and M is Ti.

### Embodiment 9

The negative electrode active material of any of embodiments 1 to 5, wherein 0≤z≤1 and M is K.

### Embodiment 10

The negative electrode active material of any of embodiments 1 to 9, wherein the composition and the layered carbonaceous material are present in an amount effective to provide a Sn:C (tin:carbon) weight ratio of 1:2 to 2:3.

### Embodiment 11

The negative electrode active material of any of embodiments 1 to 10, wherein a volume change upon intercalation with sodium to a voltage of −0.1 volts versus Na/Na⁺ is less than 70%, based on a total volume before intercalation.

### Embodiment 12

The negative electrode active material of any of embodiments 1 to 11, wherein a volume change upon intercalation with sodium to a voltage of −0.1 volts versus Na/Na⁺ is less than a volume change of the composition when not disposed between graphene layers.

### Embodiment 13

The negative electrode active material of any of embodiments 1 to 12, wherein the negative electrode material exhibits an average voltage of less than 0 volts versus Na/Na⁺.

### Embodiment 14

The negative electrode active material of any of embodiments 1 to 13, wherein the negative electrode material exhibits an average voltage of 0 to −1.1 volts versus Na/Na⁺.

### Embodiment 15

A negative electrode comprising the negative electrode active material of any of embodiments 1 to 14.

### Embodiment 16

A sodium ion battery comprising: a positive electrode comprising a positive electrode active material; a negative electrode comprising the negative electrode active material of any of embodiments 1 to 14; and an electrolyte between the positive electrode and the negative electrode.

### Embodiment 17

The sodium ion battery of embodiment 16, further comprising a separator disposed between the positive electrode and the negative electrode.

### Embodiment 18

A device comprising the sodium ion battery of embodiment 16 or 17.

### Embodiment 19

A method of making the negative electrode active material of any of embodiments 1 to 14, the method comprising: adding the composition to a suspension comprising the layered carbonaceous material to provide a mixture; immersing a metal foil in the mixture under conditions effective to adsorb the layered carbonaceous material and the composition onto the metal foil, wherein the composition is disposed between the layers of the layered carbonaceous material to provide the negative electrode active material adsorbed onto the metal foil; washing the metal foil to remove unadsorbed host and guest; and detaching the negative electrode active material from the metal foil.

The compositions, methods, and articles can alternatively comprise, consist of, or consist essentially of, any appropriate components or steps herein disclosed. The compositions, methods, and articles can additionally, or alternatively, be formulated so as to be devoid, or substantially free, of any steps, components, materials, ingredients, adjuvants, or species that are otherwise not necessary to the achievement of the function or objectives of the compositions, methods, and articles.

All ranges disclosed herein are inclusive of the endpoints, and the endpoints are independently combinable with each other. “Combinations” is inclusive of blends, mixtures, alloys, reaction products, and the like. The terms “first,” “second,” and the like, do not denote any order, quantity, or importance, but rather are used to distinguish one element from another. The terms “a” and “an” and “the” do not denote a limitation of quantity, and are to be construed to cover both the singular and the plural, unless otherwise indicated herein or clearly contradicted by context. “Or” means “and/or” unless clearly stated otherwise. Reference throughout the specification to “some embodiments”, “an embodiment”, and so forth, means that a particular element described in connection with the embodiment is included in at least one embodiment described herein, and may or may not be present in other embodiments. In addition, it is to be understood that the described elements may be combined in any suitable manner in the various embodiments.

Unless defined otherwise, technical and scientific terms used herein have the same meaning as is commonly understood by one of skill in the art to which this application belongs. All cited patents, patent applications, and other references are incorporated herein by reference in their entirety. However, if a term in the present application contradicts or conflicts with a term in the incorporated reference, the term from the present application takes precedence over the conflicting term from the incorporated reference.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

What is claimed is:

1. A negative electrode active material for a sodium-ion battery, the negative electrode active material comprising:
a layered carbonaceous material; and
a composition of the formula NaₓSn_{y-z}M_{z} disposed between layers of the layered carbonaceous material,
wherein M is Ti, K, Ge, Sb, P, or a combination thereof, and
0<x≤15, 1≤y≤5, and 0≤z≤1.

2. The negative electrode active material of claim 1, wherein the layered carbonaceous material comprises amorphous carbon, natural graphite, artificial graphite, graphene, graphene oxide, reduced graphene oxide, carbon nanotubes, or a combination thereof.

3. The negative electrode active material of claim 2, wherein the composition is disposed between graphene layers of the layered carbonaceous material.

4. The negative electrode active material of claim 1, wherein the layered carbonaceous material comprises graphene.

5. The negative electrode active material of claim 1, wherein the layered carbonaceous material comprises graphite and the composition is disposed between adjacent graphene layers of the graphite.

6. The negative electrode active material of claim 1, wherein the composition comprises Na₉Sn₄.

7. The negative electrode active material of claim 1, wherein the composition comprises Na₁₅Sn₄.

8. The negative electrode active material of claim 1, wherein 0<z≤1 and M is Ti.

9. The negative electrode active material of claim 1, wherein 0<z≤1 and M is K.

10. The negative electrode active material of claim 1, wherein the composition and the layered carbonaceous material are present in an amount effective to provide a Sn:C (tin:carbon) weight ratio of 1:2 to 2:3.

11. The negative electrode active material of claim 1, wherein a volume change upon intercalation with sodium to a voltage of −0.1 volts versus Na/Na⁺ is less than 70%, based on a total volume before intercalation.

12. The negative electrode active material of claim 1, wherein a volume change upon intercalation with sodium to a voltage of −0.1 volts versus Na/Na⁺ is less than a volume change of the composition when not disposed between graphene layers.

13. The negative electrode active material of claim 1, wherein the negative electrode material exhibits an average voltage of less than 0 volts versus Na/Na⁺.

14. The negative electrode active material of claim 3, wherein the negative electrode material exhibits an average voltage of 0 to −1.1 volts versus Na/Na⁺.

15. A negative electrode comprising the negative electrode active material of claim 1.

16. A sodium ion battery comprising:
a positive electrode comprising a positive electrode active material;
a negative electrode comprising the negative electrode active material of claim 1; and
an electrolyte between the positive electrode and the negative electrode.

17. The sodium ion battery of claim 16, further comprising a separator disposed between the positive electrode and the negative electrode.

18. A device comprising the sodium ion battery of claim 16.

19. A method of making the negative electrode active material of claim 1, the method comprising:
adding the composition to a suspension comprising the layered carbonaceous material to provide a mixture;
immersing a metal foil in the mixture under conditions effective to adsorb the layered carbonaceous material and the composition onto the metal foil, wherein the composition is disposed between the layers of the layered carbonaceous material to provide the negative electrode active material adsorbed onto the metal foil;
washing the metal foil to remove unadsorbed layered carbonaceous material and composition; and
detaching the negative electrode active material from the metal foil.
